(19) United States
(12) Patent Application Publication
(10) Pub. No.: US 2025/0286583 A1
(43) Pub. Date: Sep. 11, 2025

(54) CODEBOOK SUBSET RESTRICTION CRITERION FOR COHERENT JOINT TRANSMISSION

(71) Applicant: QUALCOMM Incorporated, San Diego, CA (US)

(72) Inventors: Min HUANG, Beijing (CN); Jing DAI, Beijing (CN); Liangming WU, Beijing (CN); Chenxi HAO, Beijing (CN); Wei XI, Beijing (CN); Chao WEI, Beijing (CN); Hao XU, Beijing (CN)

(21) Appl. No.: 18/840,698

(22) PCT Filed: Feb. 16, 2023
(86) PCT No.: PCT/CN2023/076371

§ 371 Date: Aug. 22, 2024

(30) Foreign Application Priority Data
Apr. 28, 2022 (WO) PCT/CN2022/089723

(51) Int. Cl. H04B 7/024; H04L 5/00

(52) U.S. Cl. CPC H04B 7/024; H04L 5/0035

(57) ABSTRACT

Various aspects of the present disclosure generally relate to wireless communication. In some aspects, a network node may transmit, to a user equipment (UE), a codebook subset restriction (CBSR) criterion that is associated with a coherent joint transmission (CJT) by a plurality of transmission reception points (TRPs) and that indicates that a plurality of spatial bases, associated with the plurality of TRPs, are to be jointly restricted based at least in part on the plurality of spatial bases having a same directionality. The network node may receive, from the UE, a communication that is based at least in part on the CBSR criterion. Numerous other aspects are described.

### CROSS-REFERENCE TO RELATED APPLICATION

This patent application claims priority to PCT Patent Application No. PCT/CN2022/089723, filed on Apr. 28, 2022, entitled “CODEBOOK SUBSET RESTRICTION CRITERION FOR COHERENT JOINT TRANSMISSION,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for codebook subset restriction criterion for coherent joint transmission.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a network node. The method may include transmitting, to a user equipment (UE), a codebook subset restriction (CBSR) criterion that is associated with a coherent joint transmission (CJT) by a plurality of transmission reception points (TRPs) and that indicates that a plurality of spatial bases, associated with the plurality of TRPs, are to be jointly restricted based at least in part on the plurality of spatial bases having a same directionality. The method may include receiving, from the UE, a communication that is based at least in part on the CBSR criterion.

Some aspects described herein relate to a method of wireless communication performed by a UE. The method may include receiving, from a network node, a CBSR criterion that is associated with a CJT by a plurality of TRPs and that indicates that a plurality of spatial bases, associated with the plurality of TRPs, are to be jointly restricted based at least in part on the plurality of spatial bases having a same directionality. The method may include transmitting, to the network node, a communication that is based at least in part on the CBSR criterion.

Some aspects described herein relate to an apparatus for wireless communication performed by a UE. The apparatus may include a memory and one or more processors, coupled to the memory. The one or more processors may be configured to transmit, to a UE, a CBSR criterion that is associated with a CJT by a plurality of TRPs and that indicates that a plurality of spatial bases, associated with the plurality of TRPs, are to be jointly restricted based at least in part on the plurality of spatial bases having a same directionality. The one or more processors may be configured to receive, from the UE, a communication that is based at least in part on the CBSR criterion.

Some aspects described herein relate to an apparatus for wireless communication performed by a network node. The apparatus may include a memory and one or more processors, coupled to the memory. The one or more processors may be configured to receive, from a network node, a CBSR criterion that is associated with a CJT by a plurality of TRPs and that indicates that a plurality of spatial bases, associated with the plurality of TRPs, are to be jointly restricted based at least in part on the plurality of spatial bases having a same directionality. The one or more processors may be configured to transmit, to the network node, a communication that is based at least in part on the CBSR criterion.

Some aspects described herein relate to a non-transitory computer-readable medium that stores a set of instructions for wireless communication by a network node. The set of instructions, when executed by one or more processors of the network node, may cause the network node to transmit, to a UE, a CBSR criterion that is associated with a CJT by a plurality of TRPs and that indicates that a plurality of spatial bases, associated with the plurality of TRPs, are to be jointly restricted based at least in part on the plurality of spatial bases having a same directionality. The set of instructions, when executed by one or more processors of the network node, may cause the network node to receive, from the UE, a communication that is based at least in part on the CBSR criterion.

Some aspects described herein relate to a non-transitory computer-readable medium that stores a set of instructions for wireless communication by a UE. The set of instructions, when executed by one or more processors of the UE, may cause the UE to receive, from a network node, a CBSR criterion that is associated with a CJT by a plurality of TRPs and that indicates that a plurality of spatial bases, associated with the plurality of TRPs, are to be jointly restricted based at least in part on the plurality of spatial bases having a same directionality. The set of instructions, when executed by one or more processors of the UE, may cause the UE to transmit, to the network node, a communication that is based at least in part on the CBSR criterion.

Some aspects described herein relate to an apparatus for wireless communication. The apparatus may include means for transmitting, to a UE, a CBSR criterion that is associated with a CJT by a plurality of TRPs and that indicates that a plurality of spatial bases, associated with the plurality of TRPs, are to be jointly restricted based at least in part on the plurality of spatial bases having a same directionality. The apparatus may include means for receiving, from the UE, a communication that is based at least in part on the CBSR criterion.

Some aspects described herein relate to an apparatus for wireless communication. The apparatus may include means for receiving, from a network node, a CBSR criterion that is associated with a CJT by a plurality of TRPs and that indicates that a plurality of spatial bases, associated with the plurality of TRPs, are to be jointly restricted based at least in part on the plurality of spatial bases having a same directionality. The apparatus may include means for transmitting, to the network node, a communication that is based at least in part on the CBSR criterion.

Aspects generally include a method, apparatus, system, computer program product, non-transitory computer-readable medium, user equipment, base station, wireless communication device, and/or processing system as substantially described herein with reference to and as illustrated by the drawings, specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of an open radio access network (O-RAN) architecture, in accordance with the present disclosure.

FIG. 4 is a diagram illustrating an example of a distributed RAN, in accordance with the present disclosure.

FIG. 5 is a diagram illustrating an example of multi-transmission reception point (TRP) communication, in accordance with the present disclosure.

FIG. 6 is a diagram illustrating an example of TRP coherent joint transmission (CJT), in accordance with the present disclosure.

FIG. 7 is a diagram illustrating an example associated with codebook subset restriction (CBSR) criterion for CJT, in accordance with the present disclosure.

FIG. 8 is a diagram illustrating an example associated with a precoding matrix for multi-TRP CJT with a joint codebook, in accordance with the present disclosure.

FIGS. 9A-9B are diagrams illustrating examples associated with spatial basis restriction for multi-TRP CJT with a joint codebook, in accordance with the present disclosure.

FIG. 10 is a diagram illustrating an example associated with a precoding matrix for multi-TRP CJT with separate codebooks, in accordance with the present disclosure.

FIGS. 11A-11B are diagrams illustrating examples associated with spatial basis restriction for multi-TRP CJT with separate codebooks, in accordance with the present disclosure.

FIGS. 12A-12B are diagrams illustrating examples associated with CBSR for multi-TRP, in accordance with the present disclosure.

FIG. 13 is a diagram illustrating an example process associated with a CBSR criterion for CJT, in accordance with the present disclosure.

FIG. 14 is a diagram illustrating an example process associated with a CBSR criterion for CJT, in accordance with the present disclosure.

FIG. 15 is a diagram of an example apparatus for wireless communication, in accordance with the present disclosure.

FIG. 16 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

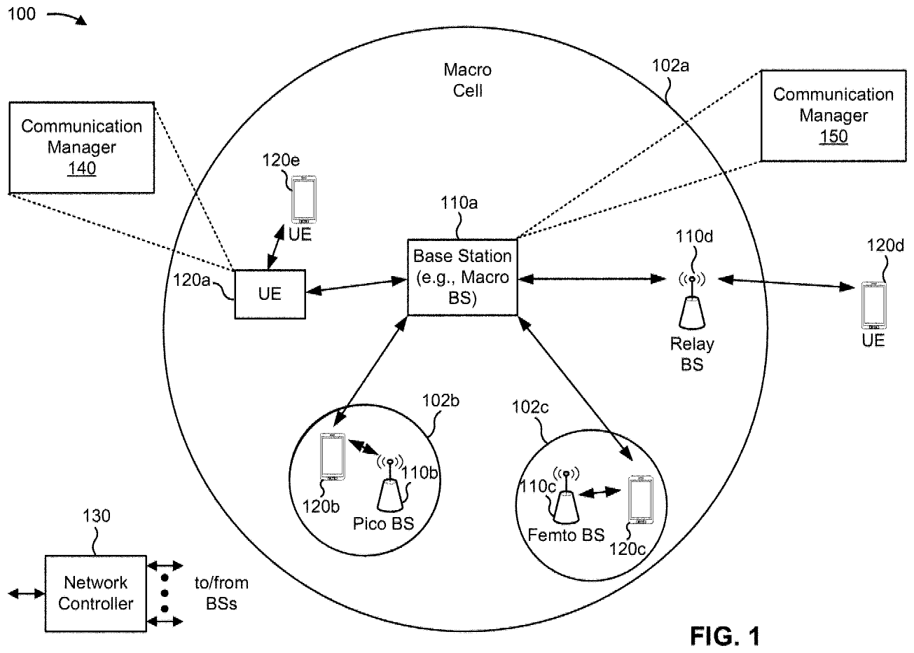

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node, a codebook subset restriction (CBSR) criterion that is associated with a coherent joint transmission (CJT) by a plurality of TRPs and that indicates that a plurality of spatial bases, associated with the plurality of TRPs, are to be jointly restricted based at least in part on the plurality of spatial bases having a same directionality; and transmit, to the network node, a communication that is based at least in part on the CBSR criterion. Additionally, or alternatively, the communication manager 140 may perform one or more other operations described herein.

In some aspects, a network node (e.g., base station 110) may include a communication manager 150. As described in more detail elsewhere herein, the communication manager 150 may transmit, to a UE, a CBSR criterion that is associated with a CJT by a plurality of TRPs and that indicates that a plurality of spatial bases, associated with the plurality of TRPs, are to be jointly restricted based at least in part on the plurality of spatial bases having a same directionality; and receive, from the UE, a communication that is based at least in part on the CBSR criterion. Additionally, or alternatively, the communication manager 150 may perform one or more other operations described herein.

As indicated above, FIG. 1 is provided as an example. Other examples may differ from what is described with regard to FIG. 1.

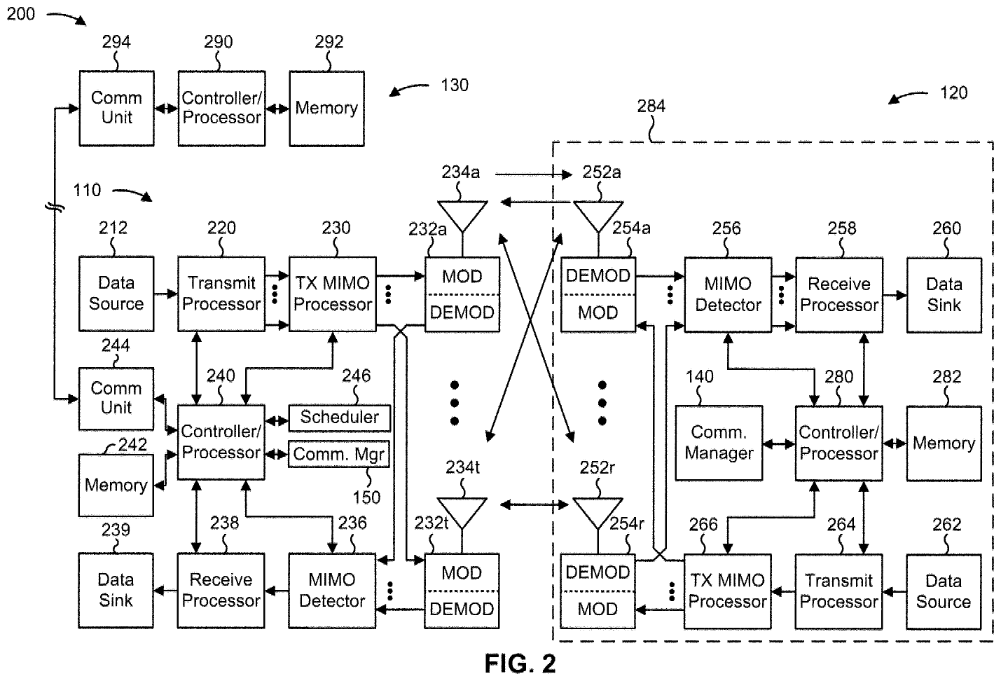

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

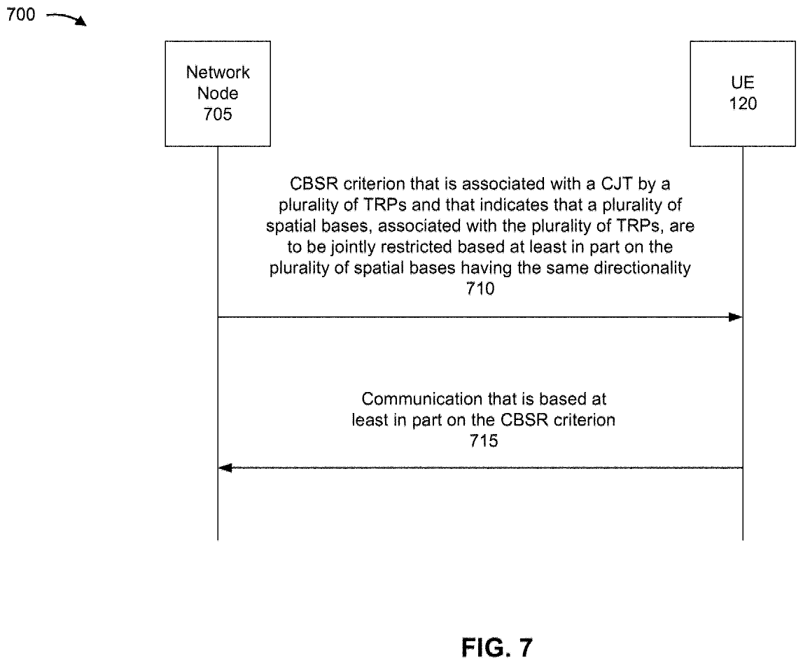

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-16).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-16).

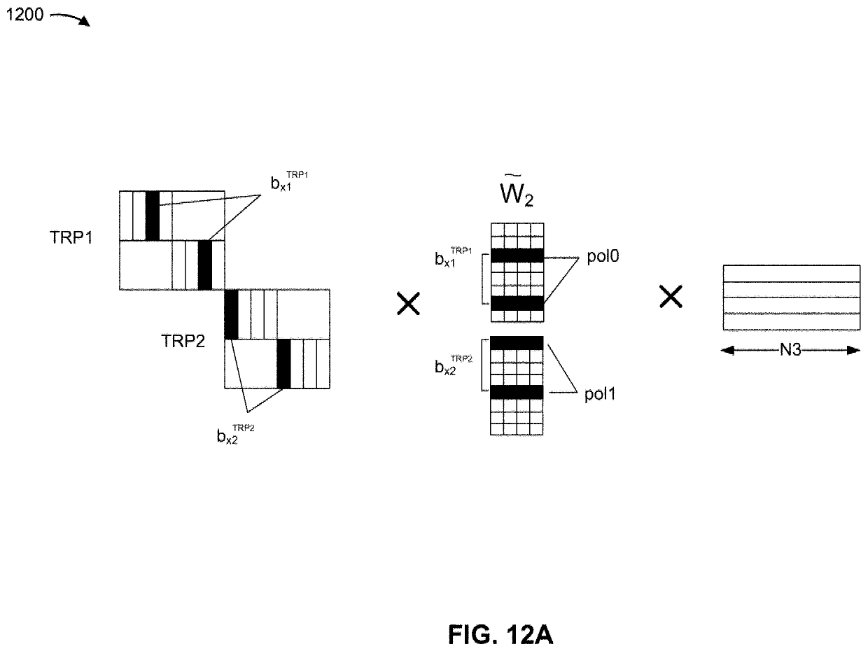

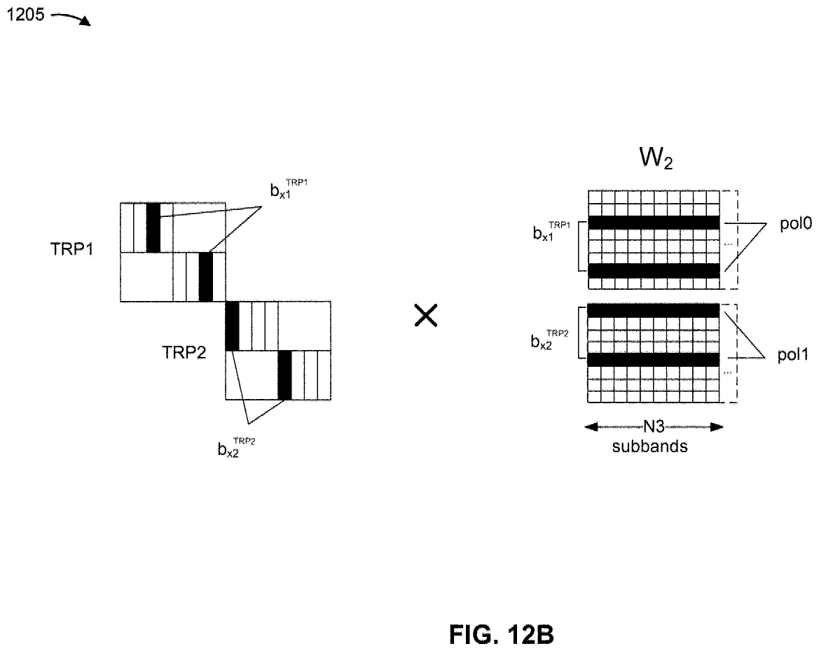

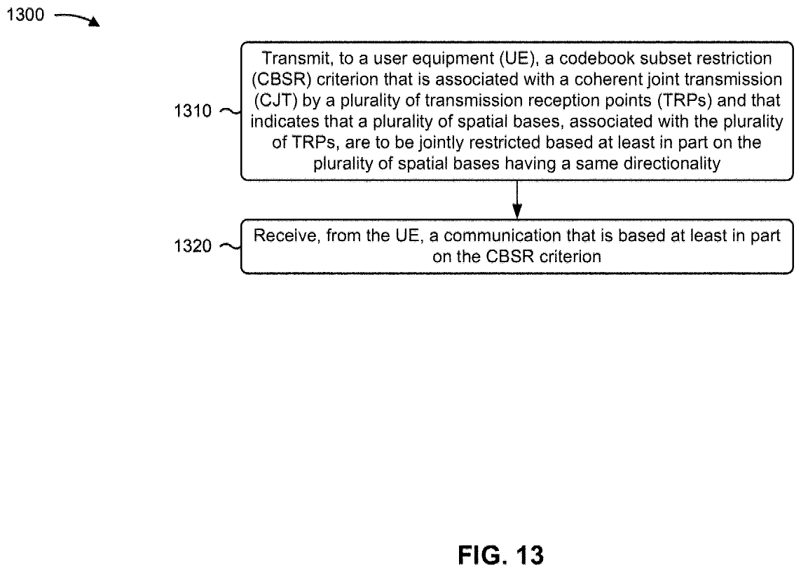

The controller/processor 240 of the base station 110, the controller/processor 280 of the UE 120, and/or any other component(s) of FIG. 2 may perform one or more techniques associated with CBSR criterion for CJT, as described in more detail elsewhere herein. For example, the controller/processor 240 of the base station 110, the controller/processor 280 of the UE 120, and/or any other component(s) of FIG. 2 may perform or direct operations of, for example, process 1200 of FIG. 12, process 1300 of FIG. 13, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, the network node includes means for transmitting, to a UE, a CBSR criterion that is associated with a CJT by a plurality of TRPs and that indicates that a plurality of spatial bases, associated with the plurality of TRPs, are to be jointly restricted based at least in part on the plurality of spatial bases having a same directionality; and/or means for receiving, from the UE, a communication that is based at least in part on the CBSR criterion. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the UE includes means for receiving, from a network node, a CBSR criterion that is associated with a CJT by a plurality of TRPs and that indicates that a plurality of spatial bases, associated with the plurality of TRPs, are to be jointly restricted based at least in part on the plurality of spatial bases having a same directionality; and/or means for transmitting, to the network node, a communication that is based at least in part on the CBSR criterion. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

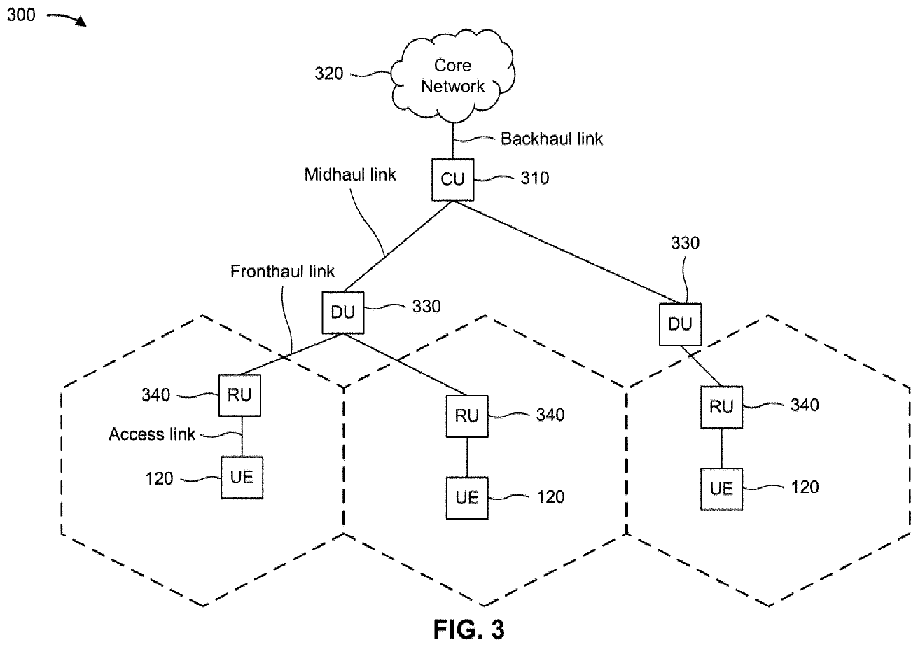

FIG. 3 is a diagram illustrating an example 300 of an O-RAN architecture, in accordance with the present disclosure. As shown in FIG. 3, the O-RAN architecture may include a central unit (CU) 310 that communicates with a core network 320 via a backhaul link. Furthermore, the CU 310 may communicate with one or more DUs 330 via respective midhaul links. The DUs 330 may each communicate with one or more RUs 340 via respective fronthaul links, and the RUs 340 may each communicate with respective UEs 120 via radio frequency (RF) access links. The DUs 330 and the RUs 340 may also be referred to as O-RAN DUs (O-DUs) 330 and O-RAN RUs (O-RUs) 340, respectively.

In some aspects, the DUs 330 and the RUs 340 may be implemented according to a functional split architecture in which functionality of a base station 110 (e.g., an eNB or a gNB) is provided by a DU 330 and one or more RUs 340 that communicate over a fronthaul link. Accordingly, as described herein, a base station 110 may include a DU 330 and one or more RUs 340 that may be co-located or geographically distributed. In some aspects, the DU 330 and the associated RU(s) 340 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 330 may correspond to a logical unit that includes one or more base station functions to control the operation of one or more RUs 340. For example, in some aspects, the DU 330 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 310. The RU(s) 340 controlled by a DU 330 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 340 handle all over the air (OTA) communication with a UE 120, and real-time and non-real-time aspects of control and user plane communication with the RU(s) 340 are controlled by the corresponding DU 330, which enables the DU(s) 330 and the CU 310 to be implemented in a cloud-based RAN architecture.

As indicated above, FIG. 3 is provided as an example. Other examples may differ from what is described with regard to FIG. 3.

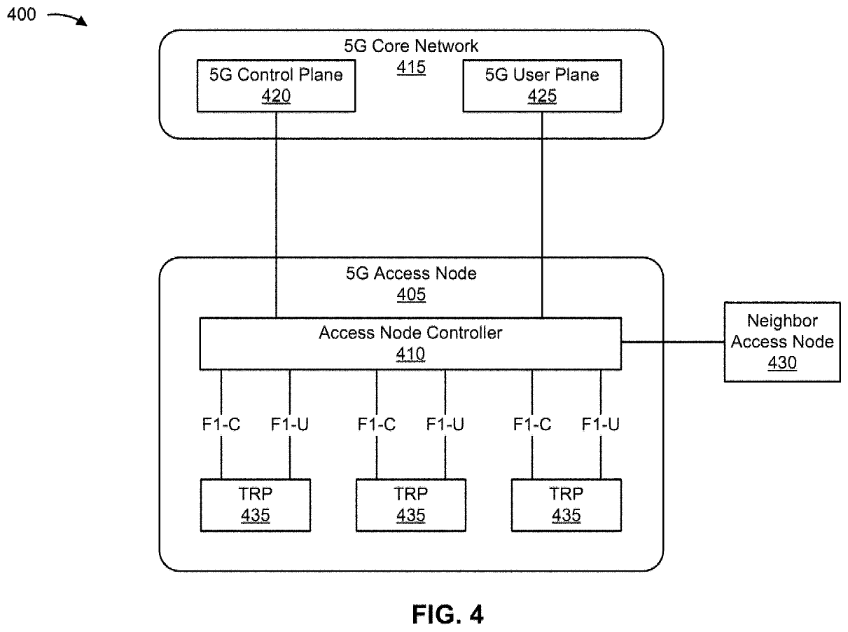

FIG. 4 illustrates an example logical architecture of a distributed RAN 400, in accordance with the present disclosure.

A 5G access node 405 may include an access node controller 410. The access node controller 410 may be a CU of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may be a distributed unit (DU) of the distributed RAN 400. In some aspects, a TRP 435 may correspond to a base station 110 described above in connection with FIG. 1. For example, different TRPs 435 may be included in different base stations 110. Additionally, or alternatively, multiple TRPs 435 may be included in a single base station 110. In some aspects, a base station 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400. For example, a PDCP layer, an RLC layer, and/or a MAC layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi co-location (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

In some cases, a plurality of TRPs (such as the TRPs 435) may be configured to perform a CJT using one or more spatial bases that are jointly restricted. Additional details regarding these features are described below.

As indicated above, FIG. 4 is provided as an example. Other examples may differ from what was described with regard to FIG. 4.

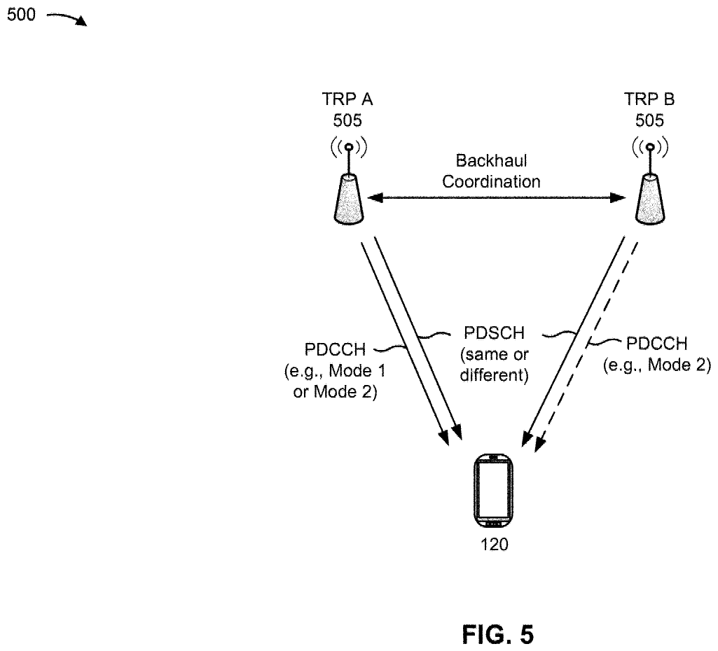

FIG. 5 is a diagram illustrating an example 500 of multi-TRP communication (sometimes referred to as multi-panel communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same base station 110 (e.g., when the TRPs 505 are different antenna arrays or panels of the same base station 110), and may have a larger delay and/or lower capacity (as compared to co-location) when the TRPs 505 are located at different base stations 110. The different TRPs 505 may communicate with the UE 120 using different QCL relationships (e.g., different TCI states), different DMRS ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

In some cases, a plurality of TRPs (such as the TRPs 505) may be configured to perform a CJT using one or more spatial bases that are jointly restricted. Additional details regarding these features are described below.

As indicated above, FIG. 5 is provided as an example. Other examples may differ from what is described with respect to FIG. 5.

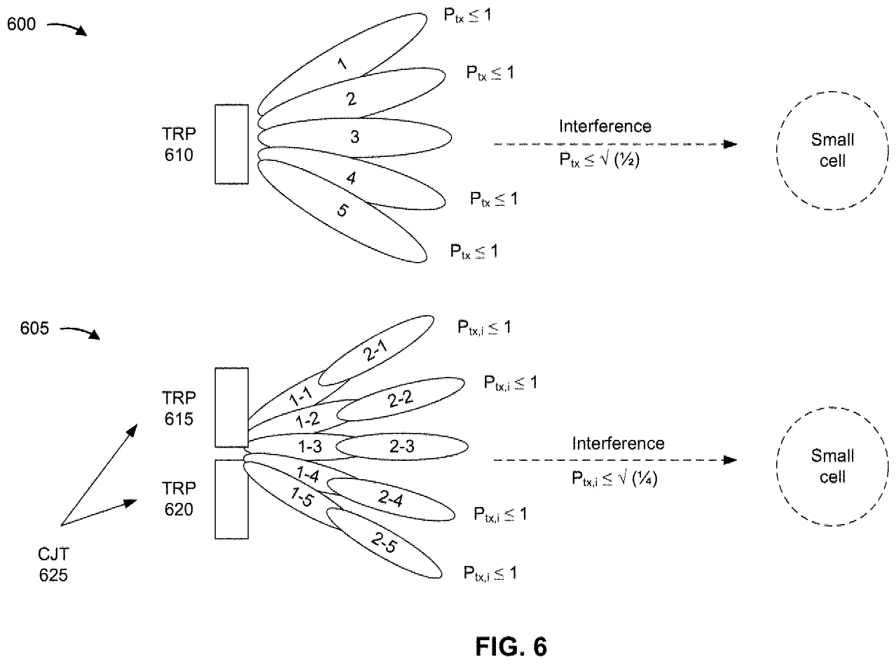

FIG. 6 is a diagram illustrating examples 600 and 605 of TRP CJT, in accordance with the present disclosure.

In some cases, sounding reference signal (SRS) enhancement may be used to manage inter-TRP cross-SRS interference via SRS capacity enhancement and/or interference randomization, with the (possible) constraints that additional resources are not consumed for the SRS, the existing comb structure for the SRS is not reused, and no new SRS root sequences are needed. In some cases, the maximum number of channel state information (CSI) reference signal (RS) (collectively, CST-RS) ports per resource may be 32 CST-RS ports. However, it may be desirable to enable a larger number of ports for low-frequency band communications with distributed TRPs (or panels).

In some cases (as shown by example 600), a single TRP 610 may be configured to transmit a plurality of beams, such as the beams 1 through 5. One or more of the beams 1-5 may be used for communicating with a small cell. In some cases (as shown by example 605), multiple TRPs may be configured to transmit a plurality of beams. For example, TRP 615 may transmit beams 1-1 through 1-5, and TRP 620 may transmit beams 2-1 through 2-5. Any of the beams 1-1 through 1-5 or 2-1 through 2-5 may be used for communicating with the small cell. The TRP 615 and the TRP 620 may perform the transmissions using CJT (as shown by reference number 625).

In some cases, a precoding matrix (as described in more detail below) may be used for CSI reporting (e.g., enhanced Type-II (eType-II) CSI reporting). The precoding matrix may be represented by the formula [symbol] . In this case, [symbol] may represent the spatial bases of a transmission, where each column corresponds to a single spatial basis. [symbol] may represent the frequency basis of the transmission, where each row corresponds to a single frequency basis. [symbol] may be a coefficient, where each element of the coefficient corresponds to a pair of spatial bases and frequency bases.

In some cases, CJT may be used in a co-located TRP scenario or in a distributed TRP scenario. In the co-located TRP scenario, the TRPs (or panels) may have the same orientation (e.g., the same directionality) or may have different orientations (e.g., different directionalities). A joint codebook for the co-located TRP scenario may be represented by the following:

$$\dot{ω} \begin{matrix}\dot{ω} , & 0 \\ 0 & \dot{ω} ,\end{matrix} \dot{ω} \dot{ω} \begin{matrix}\dot{ω} & \# \\ \dot{ω} & \#\end{matrix} .$$

[symbol]

, and [symbol] , are spatial bases matrixes for TRP 0 and TRP 1, respectively. [symbol] is the common frequency bases matrix for both TRP 0 and TRP 1. [symbol] is the coefficient matrix. [symbol] is the effective precoding matrix of TRP 0. [symbol] is the effective precoding matrix of TRP 1. In some cases, a separate codebook with co-amplitude or co-phase for the distributed TRP scenario may be represented by the following:

$$\dot{ω} \begin{matrix}\dot{ω} & \# \\ \dot{ω} & \#\end{matrix} \begin{matrix}\dot{ω} , & \dot{ω} , & \dot{ω} , \\ \dot{ω} , & \dot{ω} , & \dot{ω} ,\end{matrix} \begin{matrix}\dot{ω} , & 0 \\ 0 & \dot{ω} ,\end{matrix} \begin{matrix}\dot{ω} , & 0 & \dot{ω} , \\ 0 & \dot{ω} , & \dot{ω} ,\end{matrix} .$$

[symbol]

, and [symbol] , are frequency bases matrixes for TRP 0 and TRP 1, respectively. [symbol] , and [symbol] , are coefficient matrixes for TRP 0 and TRP 1, respectively.

In some cases, CSI-RS resources may be configured for the CJT. In one example, a single CSI-RS resource with port groups from different TRPs may be configured. In another example, multiple CSI-RS resources from different TRPs may be configured.

In some cases, CBSR may be used to reduce or avoid interference for one or more beam directions. In some cases, the TRP 610 (or a network node associated with the TRP 610) may configure the UE with a bit sequence B=B₁B₂, where B₁ represents which spatial basis group (e.g., oversampling offset) is selected, and B₂ represents the power restriction of each spatial basis in the selected spatial basis group. In some cases, one or more bits may represent a maximum average coefficient amplitude of a beam which corresponds to the spatial basis indexed by (k, x₁, x₂). The values of the one or more bits may correspond to the maximum average coefficient amplitude as shown in Table 1.

TABLE 1

| Bit | Maximum Average |
|---|---|
| b2^{(k, 2(N1x2 + x1)+1)}b2^{(k, 2(N1x2 + x1))} | Coefficient Amplitude |
| 00 | 0 |
| 01 | √(¼) |
| 10 | √(½) |
| 11 | 1 |

In some cases, for multi-TRP scenarios, CBSR may be configured separately for each TRP. However, in some cases, given the same interference threshold (e.g., corresponding to the maximum allowable interference of a small cell), the power restriction for a single TRP (e.g., TRP 610) may be different from the power restriction for each individual TRP (e.g., TRP 615 and TRP 620) in a multi-TRP scenario. The CBSR configuration may depend on whether other TRPs are transmitting at the same time. In some cases, the signal strengths for the same beam direction from the multiple TRPs may be accumulated. To ensure that an interference threshold “γ is not exceeded, the power restriction for a single-TRP network node may be [symbol] “O “γ, while the power restriction for a multi-TRP network node may be [symbol] [symbol] , “O “γ, where [symbol] , and “O are the transmit power and the channel gain, respectively, of the TRP [symbol] . In some cases configuring the CBSR separately for each TRP in the multi-TRP scenario may reduce the flexibility of the UE 120 to perform precoding matrix coefficient selection, and may result in reduced network throughput.

Techniques and apparatuses are described herein for a CBSR criterion for CJT in a multi-TRP scenario. In some aspects, a network node may transmit a CBSR criterion, that is associated with a CJT by a plurality of TRPs, and that indicates that a plurality of spatial bases, associated with the plurality of TRPs, are to be jointly restricted based at least in part on the plurality of spatial bases having the same directionality. The CBSR criterion may be associated with a CJT that includes a joint codebook for the plurality of TRPs or may be associated with a CJT that includes separate codebooks for two or more of the plurality of TRPs. The UE may perform a transmission, such as a transmission that includes a precoding matrix, that is based at least in part on the CBSR criterion.

As described above, configuring the CBSR separately for each TRP in a multi-TRP scenario may reduce the flexibility of the UE to perform precoding matrix coefficient selection and may result in reduced network throughput. Using the techniques and apparatuses described herein, the spatial bases associated with the plurality of TRPs may be jointly restricted. For example, the sum power of the spatial bases associated with the plurality of TRPs may be jointly restricted. This may lead to increased flexibility for precoding matrix coefficient selection and may increase network throughput.

As indicated above, FIG. 6 is provided as an example. Other examples may differ from what is described with respect to FIG. 6.

FIG. 7 is a diagram illustrating an example 700 of a CBSR criterion for CJT in a multi-TRP scenario, in accordance with the present disclosure. A network node 705 may communicate with the UE 120. The network node 705 may include some or all of the features of the base station 110, the CU 310, the DU 330, and/or the RU 340. In some aspects, the network node 705 may include, or may be associated with, a plurality of TRPs.

As shown in connection with reference number 710, the network node 705 may transmit, and the UE 120 may receive, a CBSR criterion that is associated with a CJT by a plurality of TRPs. The CBSR criterion may indicate that a plurality of spatial bases, associated with the plurality of TRPs, are to be jointly restricted based at least in part on the plurality of spatial bases having a same directionality.

In some aspects, a precoding matrix that is reported by the UE 120 may be represented by the following equation:

$$\dot{ω} \begin{matrix}\dot{ω ,} & 0 \\ 0 & \dot{ω} ,\end{matrix} \dot{ω} \dot{ω} .$$

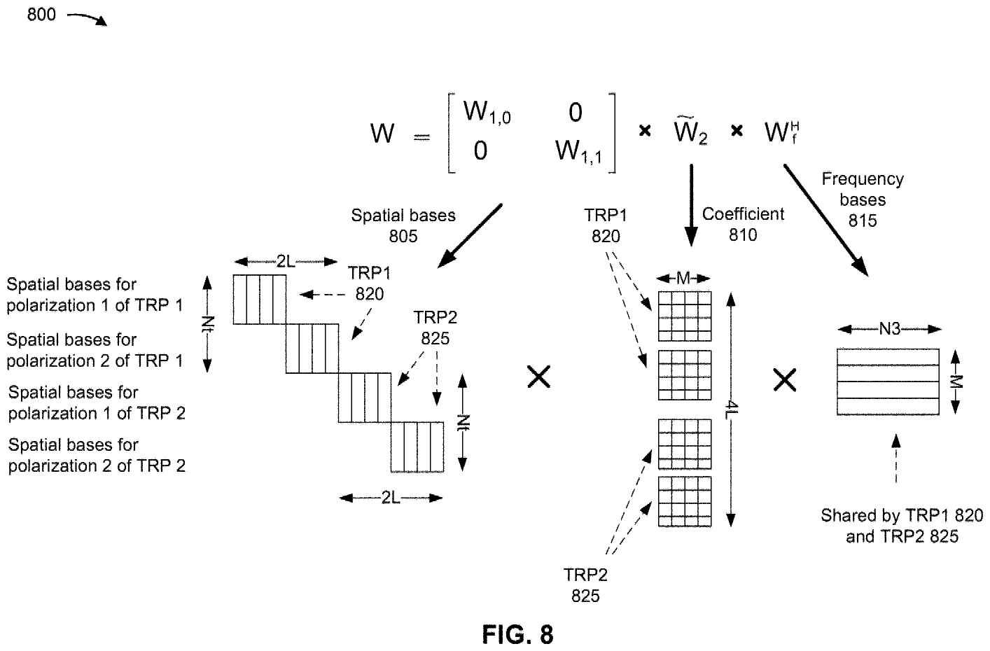

As described above, [symbol] may represent the spatial bases of a transmission, where each column corresponds to a single spatial basis. [symbol] may represent the frequency basis of the transmission, where each row corresponds to a single frequency basis. [symbol] may be a coefficient, where each element of the coefficient corresponds to a pair of spatial bases and frequency bases. In some aspects, [symbol] , [symbol] , and/or [symbol] to may be represented by a matrix. For example, [symbol] may be represented by a matrix, where each element of the matrix corresponds to a spatial basis for a polarization of a TRP. In a four element matrix, a first element may correspond to the spatial basis for polarization 1 of TRP 1, a second element may correspond to the spatial basis for polarization 2 of TRP 1, a third element may correspond to the spatial basis for polarization 1 of TRP 2, and a fourth element may correspond to the spatial basis for polarization 2 of TRP 2. Additional details regarding these features are described below in connection with FIG. 8.

In some aspects, the network node 705 may configure the CBSR criterion for a multi-TRP CJT that includes a joint codebook associated with the plurality of TRPs. For example, the network node 705 may configure the CBSR criterion for the CJT joint codebook for TRPs [symbol] 1, 2 [symbol] [symbol] . In some aspects, a number ( [symbol] ) of multi-TRP relations may be identified. Each relation may be associated with multiple spatial bases, each of which is associated with different TRPs. In some aspects, the value of [symbol] may be indicated by the network node 705 or may be configured in the UE 120. In some aspects, for each multi-TRP relation (indicated by [symbol] ), one or more spatial bases (that are indexed by [symbol] ) of each TRP may be indicated, The maximum average power of the spatial bases (from multiple TRPs) may be denoted as γ. In some aspects, [symbol] may be expressed using B as indicated in Release 15 of the 3GPP standards. In some aspects, [symbol] may be expressed as described in Release 15 of the 3GPP standards. In this case, if the plurality of TRPs have the same boresight direction (orientation), then each beam (indexed by [symbol] ) in any TRP may be paired with the same beam of other TRPs, and for each beam, a maximum average power [symbol] value may be indicated. Additionally, or alternatively, the total [symbol] [symbol] values of [symbol] may be indicated. In some aspects, [symbol] may be expressed as follows: if the plurality TRPs have different boresight directions (orientations), then one beam (indexed by [symbol] ) in each TRP may be selected, and for the selected beams, a maximum average power γ value may be indicated. In some aspects, [symbol] may be indicated using Σ [symbol] [symbol] Ω [symbol] [symbol] [symbol] Ω [symbol] bits, where [symbol] and [symbol] are antenna numbers in two dimensions of the TRP n.

In a first example for the joint codebook scenario, the sum power of the spatial bases with the same direction from all of the TRPs may be restricted for every polarization combination. For example, the sum power of the spatial bases may be restricted as follows: PGP-65E

$$\frac{1}{Σ Σ k , \text{?} ,} k , \text{?} , p , p , \text{?} , y$$

$$\text{?} \text{indicates text missing or illegible when filed}$$

for any combination [symbol] where [symbol] 0 or 1.

In some aspects, there are up to 2 different polarization combinations, and thus there are up to 2 sum power restriction formulas. In some aspects, [symbol] may represent the index of the spatial basis of TRP [symbol] (within all the selected spatial bases) in multi-TRP relation [symbol] . In some aspects, all TRPs may share the same frequency bases. In some aspects, the number of involved coefficients for each spatial basis may be equal to the number of the frequency bases ( [symbol] ). In some aspects, \grave{υ} may be based at least in part on the index layer.

In a second example for the joint codebook scenario, the sum power of the spatial bases with the same direction from all of the TRPs may be restricted for all of the polarizations. For example, the sum power of the spatial bases may be restricted as follows:

$$\frac{}{Σ Σ Σ , \text{?} ,} Σ Σ Σ k , \text{?} , p , p , \text{?} , y ,$$

$$\text{?} \text{indicates text missing or illegible when filed}$$

where \grave{η} represents the index of polarization, and \grave{η} 0 or 1.

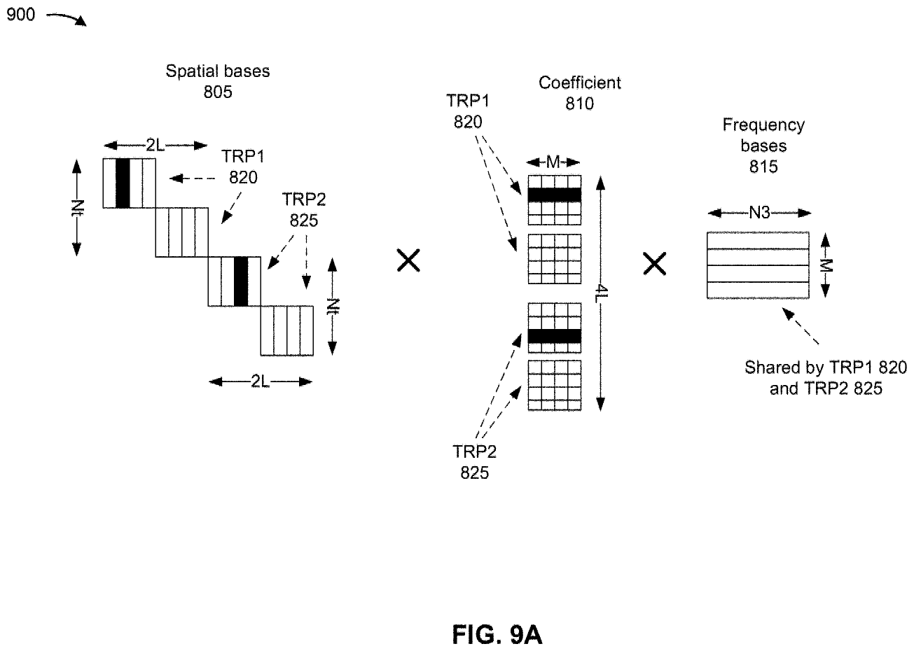

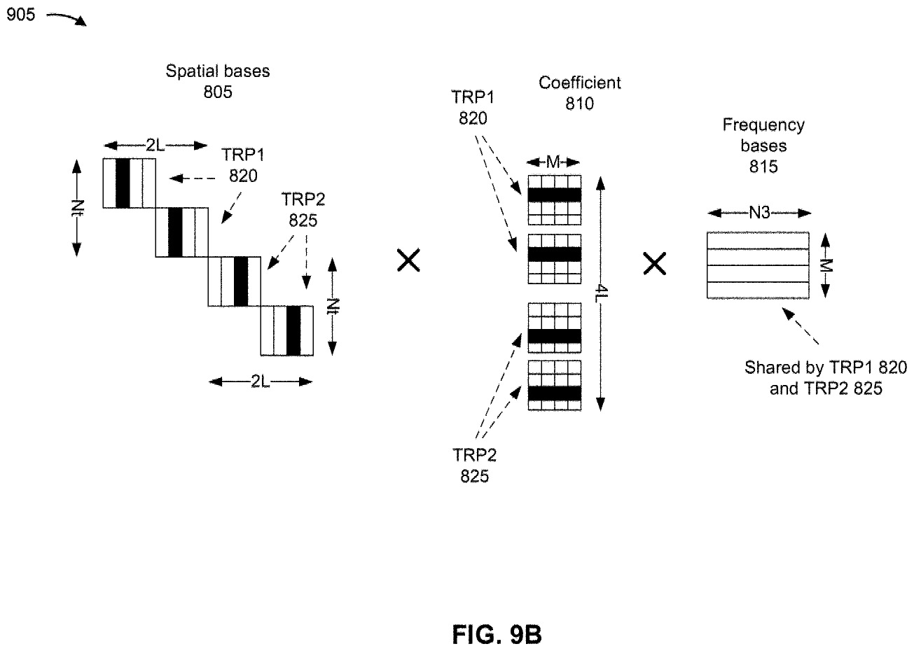

In some aspects (e.g., in the first example for the joint codebook scenario), the power of the coefficients of the polarization combination (e.g., one polarization of TRP 1 and one polarization of TRP 2) may be accumulated. For example, the network node 705 may accumulate the power of the coefficients for the one or more polarization combinations. In some aspects (e.g., in the second example for the joint codebook scenario), the power of the coefficients of all polarizations (e.g., two polarizations of TRP 1 and two polarizations of TRP 2) may be accumulated. For example, the network node 705 may accumulate the power of the coefficients for all polarizations. Additional details regarding these features are described in connection with FIGS. 9A and 9B.

In some aspects, the network node 705 may configure the CBSR criterion for a multi-TRP CJT that includes a separate codebook for two or more of the plurality of TRPs. In this case, the precoding matrix may be represented by the following equation:

$$\dot{ω} \begin{matrix}\dot{ω} & \# \\ \dot{ω} & \#\end{matrix} \begin{matrix}\dot{ω} , & \dot{ω} , & \dot{ω} , \\ \dot{ω} , & \dot{ω} , & \dot{ω} ,\end{matrix} \begin{matrix}\dot{ω} , & 0 \\ 0 & \dot{ω} ,\end{matrix} \begin{matrix}\dot{ω} , & 0 & \dot{ω} , \\ 0 & \dot{ω} , & \dot{ω} ,\end{matrix} .$$

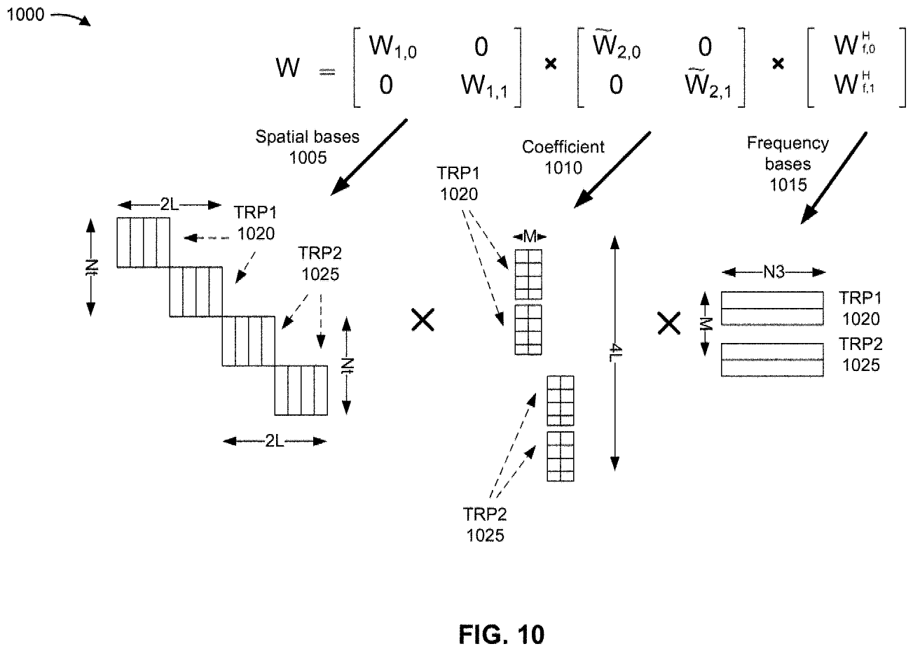

Additional details regarding multi-TRP CJT with separate codebooks are described below in connection with FIG. 10.

In some aspects, for the multi-TRP CJT with separate codebooks, each TRP may have its own frequency basis. The CBSR criterion for the CJT with the separate codebooks may be similar to the CBSR criterion for the CJT with the joint codebook. However, in the case of the multi-TRP CJT with separate codebooks, the number of coefficients for the spatial basis of one TRP may be equal to the number of frequency basis for that TRP.

In a first example for the separate codebooks, the sum power of the spatial bases with the same direction from all of the TRPs may be restricted for every polarization combination. For example, the sum power of the spatial bases may be restricted as follows:

$$\frac{}{Σ Σ , \text{?} ,} Σ Σ {}^{\text{?}} Ω , \text{?} , \dot{η} , \dot{η} , \text{?} ,$$

$$\text{?} \text{indicates text missing or illegible when filed}$$

[symbol]

for any combination [symbol] 0 or 1.

In a second example for the separate codebooks, the sum power of the spatial bases with the same direction from all of the TRPs may be restricted for all of polarizations. For example, the sum power of the spatial bases may be restricted as follows:

$$\frac{}{Σ Σ Σ , \text{?} ,} Σ Σ Σ {}^{\text{?}} Ω , \text{?} \dot{η} , \dot{η} , \text{?} ,$$

$$\text{?} \text{indicates text missing or illegible when filed}$$

[symbol]

where \grave{η} 0 [symbol] [symbol] 1.

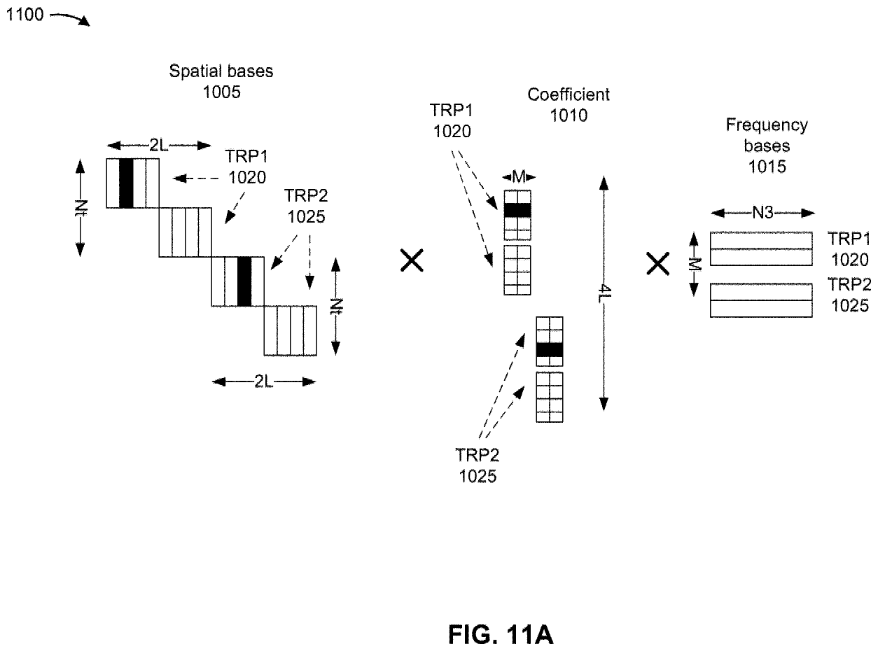

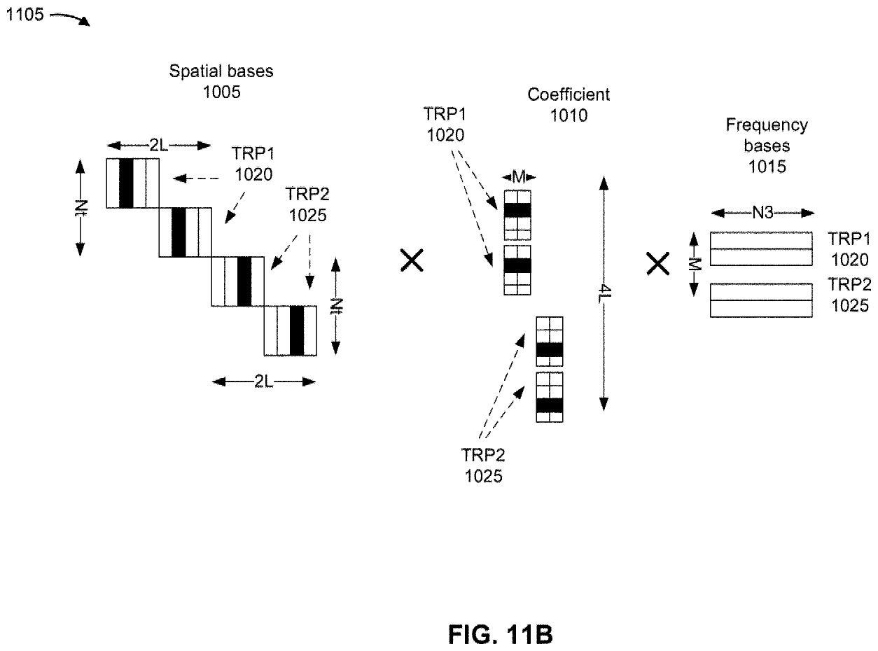

In some aspects (e.g., in the first example for the separate codebooks), the power of the coefficients for a polarization combination (e.g., one polarization of TRP 1 and one polarization of TRP 2) may be accumulated. For example, the network node 705 may accumulate the power of the coefficients for one or more polarization combinations. In some aspects (e.g., in the second example for the separate codebooks), the power of the coefficients of all polarizations (e.g., two polarizations of TRP 1 and two polarizations of TRP 2) may be accumulated. For example, the network node 705 may accumulate the power of the coefficients for all polarizations. Additional details regarding these features are described in connection with FIGS. 11A and 11B.

In some aspects, the TRPs may be associated with a CSI-RS resource or a CSI-RS resource set. In some aspects, a plurality of port groups from different TRPs may be associated with a CSI-RS resource. For example, the multi-TRP CJT CBSR criterion may be associated with a single CSR-RS resource. In some aspects, a TRP or multiple TRPs may be associated with multiple CSI-RS resources. For example, the multi-TRP CJT CBSR criterion may be associated with the multiple CSI-RS resources. If the multiple CSI-RS resources constitute a CSI-RS resource set, then the multi-TRP CJT CBSR criterion may be associated with the CSI-RS resource set.

As shown in connection with reference number 715, the UE 120 may transmit a communication that is based at least in part on the CBSR criterion. For example, the UE 120 may transmit a precoding matrix that indicates a plurality of jointly restricted spatial bases associated with the plurality of TRPs.

In one example, multiple TPS (e.g., N TRPs) may have identical-direction spatial bases. The channel gain between each TRP and the area protected by the TRPs may be equal to “O. The interference threshold of the protected area may be equal to “γ. The maximum power may be denoted as [symbol] [symbol] . Using separate ower restriction, each TRP may be configured with an individual CBSR criterion, the [symbol] , of each TRP may be determined separately, and each TRP may have a fixed maximum transmit power [symbol] , [symbol] . However, using the joint power restriction (e.g., sum power restriction) described herein, the transmit powers of all TRPs may satisfy Σ [symbol] , [symbol] , the [symbol] , of all TRPs may be determined jointly, and one TRP may have [symbol] , [symbol] as long as the other TRPs have Σ [symbol] , [symbol] [symbol] . This may provide larger flexibility for the UE 120 in determining the precoding matrix and may enable a higher throughput.

As indicated above, FIG. 7 is provided as an example. Other examples may differ from what is described with respect to FIG. 7.

FIG. 8 is a diagram illustrating an example 800 of a precoding matrix for multi-TRP CJT with a joint codebook, in accordance with the present disclosure. A precoding matrix may include a spatial bases portion 805, a coefficient portion 810, and a frequency bases portion 815. As described above in connection with FIG. 7, [symbol] may represent the spatial bases of a transmission, where each column corresponds to a single spatial basis. [symbol] may represent the frequency basis of the transmission, where each row corresponds to a single frequency basis. [symbol] may be a coefficient, where each element of the coefficient corresponds to a pair of spatial bases and frequency bases.

In some aspects, [symbol] , [symbol] , and/or [symbol] may be indicated by a matrix. For example, [symbol] may be indicated by a matrix, where each element of the matrix corresponds to a spatial basis for a polarization of a TRP. In the four element matrix shown in the example 800, a first element may correspond to the spatial basis for polarization 1 of TRP 1 820, a second element may correspond to the spatial basis for polarization 2 of TRP 1 820, a third element may correspond to the spatial basis for polarization 1 of TRP 2 825, and a fourth element may correspond to the spatial basis for polarization 2 of TRP 2 825. In this example, a value of 0 may indicate that there is no corresponding spatial basis.

As indicated above, FIG. 8 is provided as an example. Other examples may differ from what is described with respect to FIG. 8.

FIGS. 9A and 9B are diagrams illustrating examples 900 and 905 of spatial basis restriction for multi-TRP CJT with a joint codebook, in accordance with the present disclosure. As shown in FIG. 9A, for the spatial bases 805, the spatial bases may be indicated for polarization 1 of TRP1 820 and polarization 1 of TRP2 825. For example, a second spatial basis element may be indicated for polarization 1 of TRP1 820 and a third spatial basis element may be indicated for polarization 1 of TRP2 825. The frequency bases 815 may be shared by the TRP1 820 and the TRP2 825. The coefficient 810 may be configured such that the spatial bases of the TRP1 820 and the TRP2 825 are jointly restricted. As shown in FIG. 9B, for the spatial bases 805, the spatial bases may be indicated for polarization 1 of TRP1 820, polarization 2 of TRP1 820, polarization 1 of TRP2 825, and polarization 2 of TRP2 825. For example, a second spatial basis element may be indicated for polarization 1 of TRP1 820, a second spatial basis element may be indicated for polarization 2 of TRP1 820, a third spatial basis element may be indicated for polarization 1 of TRP2 825, and a third spatial basis element may be indicated for polarization 2 of TRP2 825. The frequency bases 815 may be shared by the TRP1 820 and the TRP2 825. The coefficient 810 may be configured such that the spatial bases of the TRP1 820 and the TRP2 825 are jointly restricted.

As indicated above, FIGS. 9A and 9B are provided as examples. Other examples may differ from what is described with respect to FIGS. 9A and 9B.

FIG. 10 is a diagram illustrating an example 1000 of a precoding matrix for multi-TRP CJT with separate codebooks, in accordance with the present disclosure. A precoding matrix may include a spatial bases portion 1005, a coefficient portion 1010, and a frequency bases portion 1015. As described above in connection with FIG. 7, [symbol] may represent the spatial bases of a transmission, where each column corresponds to a single spatial basis. [symbol] may represent the frequency basis of the transmission, where each row corresponds to a single frequency basis. [symbol] may be a coefficient, where each element of the coefficient corresponds to a pair of spatial bases and frequency bases.

In some aspects, [symbol] , [symbol] , and/or [symbol] may be indicated by a matrix. For example, [symbol] may be indicated by a 2×2 matrix, where a first element of the matrix corresponds to the spatial basis for polarization 1 of TRP 1 1020, a second element of the matrix corresponds to the spatial basis for polarization 2 of TRP 1 1020, a third element of the matrix corresponds to the spatial basis for polarization 1 of TRP 2 1025, and a fourth element of the matrix corresponds to the spatial basis for polarization 2 of TRP 2 1025. [symbol] may be indicated by a 2×2 matrix, where the first row of the matrix indicates coefficients associated with the TRP1 1020 and the second row of the matrix indicates coefficients associated with the TRP2 1025. [symbol] may be indicated by a 2×1 matrix, where the first row of the matrix indicates the frequency basis for the TRP1 1020, and the second row of the matrix indicates the frequency basis for the TRP2 1025.

As indicated above, FIG. 10 is provided as an example. Other examples may differ from what is described with respect to FIG. 10.

FIGS. 11A and 11B are diagrams illustrating examples 1100 and 1105 of spatial basis restriction for multi-TRP CJT with separate codebooks, in accordance with the present disclosure. As shown in FIG. 11A, for the spatial bases 1005, the spatial bases may be indicated for polarization 1 of TRP1 1020 and polarization 1 of TRP2 1025. For example, a second spatial basis element may be indicated for polarization 1 of TRP1 1020, and a third spatial basis element may be indicated for polarization 1 of TRP2 1025. The frequency bases 1015 be split into frequency bases for the TRP1 1020 and frequency bases for the TRP2 1025. The coefficient 1010 may be configured such that the spatial bases of the TRP1 1020 and the TRP2 1025 are jointly restricted. As shown in FIG. 11B, for the spatial bases 1005, the spatial bases may be indicated for polarization 1 of TRP1 1020, polarization 2 of TRP1 1020, polarization 1 of TRP2 1025, and polarization 2 of TRP2 1025. For example, a second spatial basis element may be indicated for polarization 1 of TRP1 1020, a second spatial basis element may be indicated for polarization 2 of TRP1 1020, a third spatial basis element may be indicated for polarization 1 of TRP2 1025, and a third spatial basis element may be indicated for polarization 2 of TRP2 1025. The frequency bases 1015 be split into frequency bases for the TRP1 1020 and frequency bases for the TRP2 1025. The coefficient 810 may be configured such that the spatial bases of the TRP1 1020 and the TRP2 1025 are jointly restricted.

As indicated above, FIGS. 11A and 11B are provided as examples. Other examples may differ from what is described with respect to FIGS. 11A and 11B.

FIGS. 12A-12B are diagrams illustrating examples 1200 and 1205 of CBSR for multi-TRP, in accordance with the present disclosure.

In some aspects, for multi-TRP, interference restriction for an area (e.g., for a certain geometry zone) may be based at least in part on a summated power of certain beam combinations from different TRPs. For example, interference restriction for a first zone may be based at least in part on a summated power of certain beam combinations from TRP1 and TRP2, while interference restriction for a second zone may be based at least in part on a summated power of certain beam combinations from TRP1, TRP2, and TRP3. In this case, it may be beneficial to configure a summated power restriction of the multiple beam combinations and TRP combinations. In some cases, such as in Release 15 of the 3GPP specification, the frequency domain may be used to restrict the power of one or more sub-bands. In some other cases, such as in Release 16 of the 3GPP specification, a delay-domain may be used to restrict a sum or average power across all sub-bands (e.g., for wideband power). In some aspects, a CBSR for a precoding matrix indicator (PMI) may be extended to the multi-TRP scenario.

In some aspects, for a CJT multi-TRP CSI report, the network node 110 may configure a total power restriction (e.g., CBSR) for more than one beam from different combinations of TRPs. In an example with four TRPs (e.g., TRP1, TRP2, TRP3, and TRP4), a TRP combination may be the full set {TRP1, TRP2, TRP3, and TRP4}, or any subset of the TRPs, such as {TRP1, TRP2, TRP3} or {TRP1, TRP4}, among other examples. A single TRP case, such as {TRP1} or {TRP2}, may also be included. In some aspects, for a beam combination configured with total-power-CBSR, each beam may be from a different TRP. In one example, each beam combination [symbol] is from {TRP1, TRP2, TRP3}, respectively. For a TRP combination, more than one beam combination can be configured, each having a total-power-CBSR configuration. For example, {TRP1, TRP2, TRP3} can be configured with total-power-CBSR beam combinations [symbol] or [symbol] among other examples.

As shown in FIG. 12A, for a configured beam combination [symbol] , [symbol] from {TRP1, TRP2}, respectively, the average squared summation of [symbol] coefficients (e.g., power) may satisfy a configured threshold [symbol] .

$$\frac{1}{2 \ddot{u}} \text{?} \dot{η} , \dot{η} , \text{?} , \text{?} \dot{η} , \dot{η} , \text{?} , \text{?}$$

$$\text{?} \text{indicates text missing or illegible when filed}$$

where [symbol] is a layer index, [symbol] or [symbol] is an SD basis index, \acute{α} is an FD basis index, p=0.1 is a pol index, and [symbol] is a total SD basis selected for all TRPs. In some aspects, either polarization may satisfy the total-power CBSR.

The example above is based on a delay-domain, which may only restrict wideband average or total precoding power, but may not be able to assure a power restriction for every sub-band.

As shown in FIG. 12B, for FD-based restriction, the power may be based on FD coefficients [symbol] (where a size of the [symbol] matrix is 2 [symbol] [symbol] , [symbol] is the number of SD bases selected for all TRPs, and [symbol] is the number of sub-bands). The coefficient amplitudes of W may be denoted as q [symbol] and q [symbol] for a configured beam C combination [symbol] from {TRP1, TRP2}, respectively, where k is a subband index. For every sub-band [symbol] 0, . . . , [symbol] 1, the total-power CBSR may be specified as:

$$\frac{1}{2 M} q , \text{?} , \text{?} q , \text{?} , \text{?} y$$

$$\text{?} \text{indicates text missing or illegible when filed}$$

In some aspects, such as in the example above, explicit CBSR may be used. In this case, the UE-reported PMI may satisfy the power restriction. However, the UE may need to clip the calculated precoder. In some other aspects, implicit CBSR may be used. This may reduce UE complexity. For example, the UE may not need to clip the precoder, and there may be no impact to the PMI report. In some aspects, such as for total-power CBSR, the UE may not need to report a PMI to satisfy the configured total-power CBSR (for certain beam and TRP combinations), and instead, may only report the CQI assuming the total-power CBSR. In this case, the network node 110 may clip the precoding based at least in part on the total-power CBSR (e.g., without using an amplitude quantization), with the corresponding CQI known.

As indicated above, FIGS. 12A and 12B are provided as examples. Other examples may differ from what is described with respect to FIGS. 12A and 12B.

FIG. 13 is a diagram illustrating an example process 1300 performed, for example, by a network node, in accordance with the present disclosure. Example process 1300 is an example where the network node (e.g., network node 705) performs operations associated with CBSR criterion for CJT. The network node may include some or all of the features of the UE 120, the CU 310, the DU 330, and/or the RU 340.

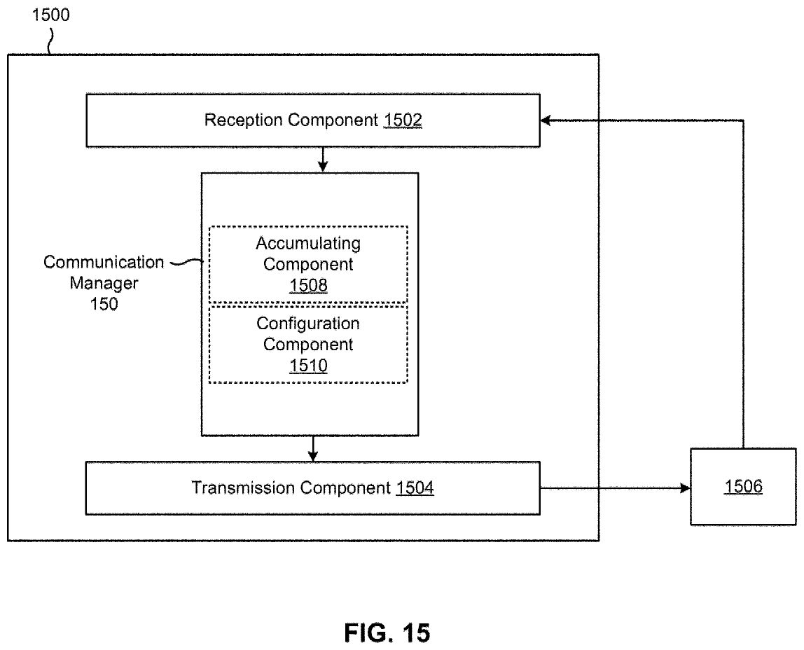

As shown in FIG. 13, in some aspects, process 1300 may include transmitting, to a UE, a CBSR criterion that is associated with a CJT by a plurality of TRPs and that indicates that a plurality of spatial bases, associated with the plurality of TRPs, are to be jointly restricted based at least in part on the plurality of spatial bases having a same directionality (block 1310). For example, the network node (e.g., using communication manager 150 and/or transmission component 1504, depicted in FIG. 15) may transmit, to a UE, a CBSR criterion that is associated with a CJT by a plurality of TRPs and that indicates that a plurality of spatial bases, associated with the plurality of TRPs, are to be jointly restricted based at least in part on the plurality of spatial bases having a same directionality, as described above.

As further shown in FIG. 13, in some aspects, process 1300 may include receiving, from the UE, a communication that is based at least in part on the CBSR criterion (block 1320). For example, the network node (e.g., using communication manager 150 and/or reception component 1502, depicted in FIG. 15) may receive, from the UE, a communication that is based at least in part on the CBSR criterion, as described above.

Process 1300 may include additional aspects, such as any single aspect or any combination of aspects described below and/or in connection with one or more other processes described elsewhere herein.

In a first aspect, transmitting the CBSR criterion comprises transmitting a CBSR criterion for a CJT that includes a joint codebook for the plurality of TRPs.

In a second aspect, alone or in combination with the first aspect, the CBSR criterion for the CJT that includes the joint codebook for the plurality of TRPs indicates a number of relations associated with the plurality of TRPs, wherein each relation of the number of relations is associated with two or more spatial bases of the plurality of spatial bases, and wherein the two or more spatial bases are associated with different TRPs of the plurality of TRPs.

In a third aspect, alone or in combination with one or more of the first and second aspects, transmitting the CBSR criterion comprises transmitting a CBSR criterion for a CJT that includes separate codebooks for two or more of the plurality of TRPs.

In a fourth aspect, alone or in combination with one or more of the first through third aspects, a number of coefficients for a spatial basis, of the plurality of spatial bases, is equal to a number of frequency bases for a corresponding TRP of the plurality of TRPs.

In a fifth aspect, alone or in combination with one or more of the first through fourth aspects, process 1300 includes transmitting an indication of a maximum average power associated with the plurality of spatial bases.

In a sixth aspect, alone or in combination with one or more of the first through fifth aspects, transmitting the indication of the maximum average power comprises pairing a spatial basis of a first TRP, of the plurality of TRPs, with a corresponding spatial basis of a second TRP, of the plurality of TRPs, based at least in part on the first TRP and the second TRP having a same orientation, and transmitting a maximum average power associated with the spatial basis of the first TRP and the corresponding spatial basis of the second TRP.

In a seventh aspect, alone or in combination with one or more of the first through sixth aspects, transmitting the indication of the maximum average power comprises selecting a spatial basis of a first TRP, of the plurality of TRPs, and selecting a spatial basis of a second TRP, of the plurality of TRPs, based at least in part on the first TRP and the second TRP having different orientations, and transmitting a maximum average power associated with the selected spatial basis of the first TRP and the selected spatial basis of the second TRP.

In an eighth aspect, alone or in combination with one or more of the first through seventh aspects, transmitting the CBSR criterion comprises transmitting a CBSR criterion indicating that the plurality of spatial bases are to be jointly restricted for every polarization combination of a plurality of polarization combinations associated with the TRPs.

In a ninth aspect, alone or in combination with one or more of the first through eighth aspects, process 1300 includes accumulating a power of a plurality of coefficients associated with the plurality of polarization combinations.

In a tenth aspect, alone or in combination with one or more of the first through ninth aspects, transmitting the CBSR criterion comprises transmitting a CBSR criterion indicating that the plurality of spatial bases are to be jointly restricted for all polarizations of a plurality of polarizations associated with the TRPs.

In an eleventh aspect, alone or in combination with one or more of the first through tenth aspects, process 1300 includes accumulating a power of a plurality of coefficients associated with the plurality of polarizations.

In a twelfth aspect, alone or in combination with one or more of the first through eleventh aspects, the CJT is associated with a CSI-RS resource.

In a thirteenth aspect, alone or in combination with one or more of the first through twelfth aspects, the plurality of TRPs are associated with a plurality of port groups.

In a fourteenth aspect, alone or in combination with one or more of the first through thirteenth aspects, a first TRP, of the plurality of TRPs, and a second TRP, of the plurality of TRPs, are associated with different channel state information reference signal resources.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

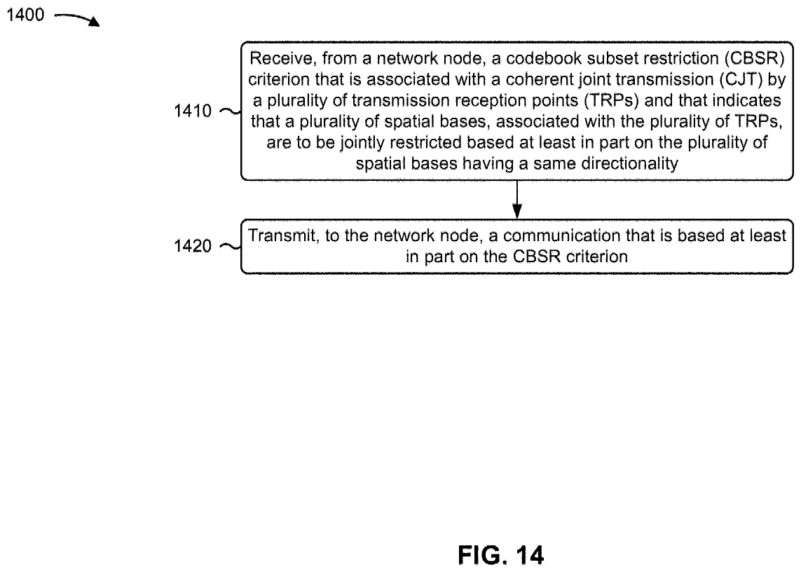

FIG. 14 is a diagram illustrating an example process 1400 performed, for example, by a UE, in accordance with the present disclosure. Example process 1400 is an example where the UE (e.g., UE 120) performs operations associated with CBSR criterion for CJT.

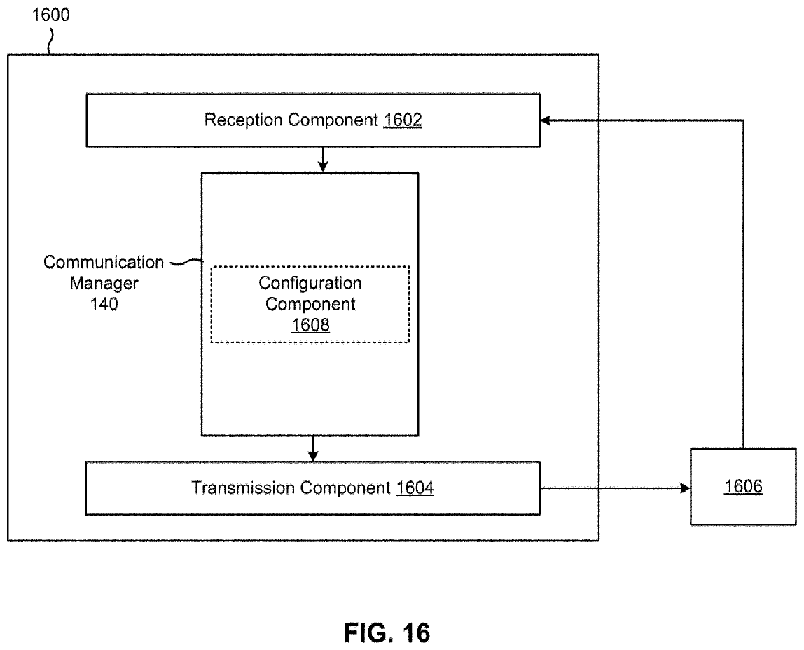

As shown in FIG. 14, in some aspects, process 1400 may include receiving, from a network node, a CBSR criterion that is associated with a CJT by a plurality of TRPs and that indicates that a plurality of spatial bases, associated with the plurality of TRPs, are to be jointly restricted based at least in part on the plurality of spatial bases having a same directionality (block 1410). For example, the UE (e.g., using communication manager 140 and/or reception component 1602, depicted in FIG. 16) may receive, from a network node, a CBSR criterion that is associated with a CJT by a plurality of TRPs and that indicates that a plurality of spatial bases, associated with the plurality of TRPs, are to be jointly restricted based at least in part on the plurality of spatial bases having a same directionality, as described above.

As further shown in FIG. 14, in some aspects, process 1400 may include transmitting, to the network node, a communication that is based at least in part on the CBSR criterion (block 1420). For example, the UE (e.g., using communication manager 140 and/or transmission component 1604, depicted in FIG. 16) may transmit, to the network node, a communication that is based at least in part on the CBSR criterion, as described above.

Process 1400 may include additional aspects, such as any single aspect or any combination of aspects described below and/or in connection with one or more other processes described elsewhere herein.

In a first aspect, receiving the CBSR criterion comprises receiving a CBSR criterion for a CJT that includes a joint codebook for the plurality of TRPs.

In a second aspect, alone or in combination with the first aspect, the CBSR criterion for the CJT that includes the joint codebook for the plurality of TRPs indicates a number of relations associated with the plurality of TRPs, wherein each relation of the number of relations is associated with two or more spatial bases of the plurality of spatial bases, and wherein the two or more spatial bases are associated with different TRPs of the plurality of TRPs.

In a third aspect, alone or in combination with one or more of the first and second aspects, receiving the CBSR criterion comprises receiving a CBSR criterion for a CJT that includes separate codebooks for each of the plurality of TRPs.

In a fourth aspect, alone or in combination with one or more of the first through third aspects, a number of coefficients for a spatial basis, of the plurality of spatial bases, is equal to a number of frequency bases for a corresponding TRP of the plurality of TRPs.

In a fifth aspect, alone or in combination with one or more of the first through fourth aspects, process 1400 includes receiving an indication of a maximum average power associated with the plurality of spatial bases.

In a sixth aspect, alone or in combination with one or more of the first through fifth aspects, receiving the indication of the maximum average power comprises receiving a maximum average power associated with a spatial basis of a first TRP, of the plurality of TRPs, and a corresponding spatial basis of a second TRP, of the plurality of TRPs, based at least in part on the first TRP and the second TRP having a same orientation.

In a seventh aspect, alone or in combination with one or more of the first through sixth aspects, receiving the indication of the maximum average power comprises receiving a maximum average power associated with a selected spatial basis of a first TRP, of the plurality of TRPs, and a selected spatial basis of a second TRP, of the plurality of TRPs, based at least in part on the first TRP and the second TRP having different orientations.

In an eighth aspect, alone or in combination with one or more of the first through seventh aspects, receiving the CBSR criterion comprises receiving a CBSR criterion indicating that the plurality of spatial bases are to be jointly restricted for every polarization combination of a plurality of polarization combinations associated with the TRPs.

In a ninth aspect, alone or in combination with one or more of the first through eighth aspects, receiving the CBSR criterion comprises receiving a CBSR criterion indicating that the plurality of spatial bases are to be jointly restricted for all polarizations of a plurality of polarizations associated with the TRPs.

In a tenth aspect, alone or in combination with one or more of the first through ninth aspects, the CJT is associated with a CSI-RS resource.

In an eleventh aspect, alone or in combination with one or more of the first through tenth aspects, the plurality of TRPs are associated with a plurality of port groups.

In a twelfth aspect, alone or in combination with one or more of the first through eleventh aspects, a first TRP, of the plurality of TRPs, and a second TRP, of the plurality of TRPs, are associated with different channel state information reference signal resources.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication. The apparatus 1500 may be a network node, or a network node may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 150. The communication manager 150 may include one or more of an accumulating component 1508 or a configuration component 1510, among other examples.

In some aspects, the apparatus 1500 may be configured to perform one or more operations described herein in connection with FIGS. 7, 8, 9A, 9B, 10, 11A, 11B, 12A and/or 12B. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

The transmission component 1504 may transmit, to a UE, a CBSR criterion that is associated with a CJT by a plurality of TRPs and that indicates that a plurality of spatial bases, associated with the plurality of TRPs, are to be jointly restricted based at least in part on the plurality of spatial bases having a same directionality. The reception component 1502 may receive, from the UE, a communication that is based at least in part on the CBSR criterion.

The transmission component 1504 may transmit an indication of a maximum average power associated with the plurality of spatial bases.

The accumulating component 1508 may accumulate a power of a plurality of coefficients associated with the plurality of polarization combinations.

The accumulating component 1508 may accumulate a power of a plurality of coefficients associated with the plurality of polarizations.

The configuration component 1510 may transmit configuration information associated with the CBSR criterion.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication. The apparatus 1600 may be a UE, or a UE may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 140. The communication manager 140 may include one or more of a configuration component 1608, among other examples.

In some aspects, the apparatus 1600 may be configured to perform one or more operations described herein in connection with FIGS. 7, 8, 9A, 9B, 10, 11A, 11B, 12A and/or 12B. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the UE described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the UE described in connection with FIG. 2. In some aspects, the transmission component 1604 may be co-located with the reception component 1602 in a transceiver.

The reception component 1602 may receive, from a network node, a CBSR criterion that is associated with a CJT by a plurality of TRPs and that indicates that a plurality of spatial bases, associated with the plurality of TRPs, are to be jointly restricted based at least in part on the plurality of spatial bases having a same directionality. The transmission component 1604 may transmit, to the network node, a communication that is based at least in part on the CBSR criterion.

The reception component 1602 may receive an indication of a maximum average power associated with the plurality of spatial bases.

The configuration component 1608 may transmit configuration information associated with the CBSR criterion.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a network node, comprising: transmitting, to a user equipment (UE), a codebook subset restriction (CBSR) criterion that is associated with a coherent joint transmission (CJT) by a plurality of transmission reception points (TRPs) and that indicates that a plurality of spatial bases, associated with the plurality of TRPs, are to be jointly restricted based at least in part on the plurality of spatial bases having a same directionality; and receiving, from the UE, a communication that is based at least in part on the CBSR criterion.

Aspect 2: The method of Aspect 1, wherein transmitting the CBSR criterion comprises transmitting a CBSR criterion for a CJT that includes a joint codebook for the plurality of TRPs.

Aspect 3: The method of Aspect 2, wherein the CBSR criterion for the CJT that includes the joint codebook for the plurality of TRPs indicates a number of relations associated with the plurality of TRPs, wherein each relation of the number of relations is associated with two or more spatial bases of the plurality of spatial bases, and wherein the two or more spatial bases are associated with different TRPs of the plurality of TRPs.

Aspect 4: The method of any of Aspects 1-3, wherein transmitting the CBSR criterion comprises transmitting a CBSR criterion for a CJT that includes separate codebooks for two or more of the plurality of TRPs.

Aspect 5: The method of Aspect 4, wherein a number of coefficients for a spatial basis, of the plurality of spatial bases, is equal to a number of frequency bases for a corresponding TRP of the plurality of TRPs.

Aspect 6: The method of any of Aspects 1-5, further comprising transmitting an indication of a maximum average power associated with the plurality of spatial bases.

Aspect 7: The method of Aspect 6, wherein transmitting the indication of the maximum average power comprises: pairing a spatial basis of a first TRP, of the plurality of TRPs, with a corresponding spatial basis of a second TRP, of the plurality of TRPs, based at least in part on the first TRP and the second TRP having a same orientation; and transmitting a maximum average power associated with the spatial basis of the first TRP and the corresponding spatial basis of the second TRP.

Aspect 8: The method of Aspect 6, wherein transmitting the indication of the maximum average power comprises: selecting a spatial basis of a first TRP, of the plurality of TRPs, and selecting a spatial basis of a second TRP, of the plurality of TRPs, based at least in part on the first TRP and the second TRP having different orientations; and transmitting a maximum average power associated with the selected spatial basis of the first TRP and the selected spatial basis of the second TRP.

Aspect 9: The method of any of Aspects 1-8, wherein transmitting the CBSR criterion comprises transmitting a CBSR criterion indicating that the plurality of spatial bases are to be jointly restricted for every polarization combination of a plurality of polarization combinations associated with the TRPs.

Aspect 10: The method of Aspect 9, further comprising accumulating a power of a plurality of coefficients associated with the plurality of polarization combinations.

Aspect 11: The method of any of Aspects 1-10, wherein transmitting the CBSR criterion comprises transmitting a CBSR criterion indicating that the plurality of spatial bases are to be jointly restricted for all polarizations of a plurality of polarizations associated with the TRPs.

Aspect 12: The method of Aspect 11, further comprising accumulating a power of a plurality of coefficients associated with the plurality of polarizations.

Aspect 13: The method of any of Aspects 1-12, wherein the CJT is associated with a channel state information reference signal resource and the plurality of TRPs are associated with a plurality of port groups.

Aspect 14: The method of Aspects 1-13, wherein the plurality of TRPs are associated with a plurality of channel state information reference signal resources.

Aspect 15: The method of any of Aspects 1-14, wherein a first TRP, of the plurality of TRPs, and a second TRP, of the plurality of TRPs, are associated with different channel state information reference signal resources.

Aspect 16: A method of wireless communication performed by a user equipment (UE), comprising: receiving, from a network node, a codebook subset restriction (CBSR) criterion that is associated with a coherent joint transmission (CJT) by a plurality of transmission reception points (TRPs) and that indicates that a plurality of spatial bases, associated with the plurality of TRPs, are to be jointly restricted based at least in part on the plurality of spatial bases having a same directionality; and transmitting, to the network node, a communication that is based at least in part on the CBSR criterion.

Aspect 17: The method of Aspect 16, wherein receiving the CBSR criterion comprises receiving a CBSR criterion for a CJT that includes a joint codebook for the plurality of TRPs.

Aspect 18: The method of Aspect 17, wherein the CBSR criterion for the CJT that includes the joint codebook for the plurality of TRPs indicates a number of relations associated with the plurality of TRPs, wherein each relation of the number of relations is associated with two or more spatial bases of the plurality of spatial bases, and wherein the two or more spatial bases are associated with different TRPs of the plurality of TRPs.

Aspect 19: The method of any of Aspects 16-18, wherein receiving the CBSR criterion comprises receiving a CBSR criterion for a CJT that includes separate codebooks for each of the plurality of TRPs.

Aspect 20: The method of Aspect 19, wherein a number of coefficients for a spatial basis, of the plurality of spatial bases, is equal to a number of frequency bases for a corresponding TRP of the plurality of TRPs.

Aspect 21: The method of any of Aspects 16-20, further comprising receiving an indication of a maximum average power associated with the plurality of spatial bases.

Aspect 22: The method of Aspect 21, wherein receiving the indication of the maximum average power comprises receiving a maximum average power associated with a spatial basis of a first TRP, of the plurality of TRPs, and a corresponding spatial basis of a second TRP, of the plurality of TRPs, based at least in part on the first TRP and the second TRP having a same orientation.

Aspect 23: The method of Aspect 21, wherein receiving the indication of the maximum average power comprises receiving a maximum average power associated with a selected spatial basis of a first TRP, of the plurality of TRPs, and a selected spatial basis of a second TRP, of the plurality of TRPs, based at least in part on the first TRP and the second TRP having different orientations.

Aspect 24: The method of any of Aspects 16-23, wherein receiving the CBSR criterion comprises receiving a CBSR criterion indicating that the plurality of spatial bases are to be jointly restricted for every polarization combination of a plurality of polarization combinations associated with the TRPs.

Aspect 25: The method of any of Aspects 16-24, wherein receiving the CBSR criterion comprises receiving a CBSR criterion indicating that the plurality of spatial bases are to be jointly restricted for all polarizations of a plurality of polarizations associated with the TRPs.

Aspect 26: The method of any of Aspects 16-25, wherein the CJT is associated with a channel state information reference signal resource and the plurality of TRPs are associated with a plurality of port groups.

Aspect 27: The method of Aspects 16-26, wherein the plurality of TRPs are associated with a plurality of channel state information reference signal resources.

Aspect 28: The method of any of Aspects 16-27, wherein a first TRP, of the plurality of TRPs, and a second TRP, of the plurality of TRPs, are associated with different channel state information reference signal resources.

Aspect 29: An apparatus for wireless communication at a device, comprising a processor, memory coupled with the processor, and instructions stored in the memory and executable by the processor to cause the apparatus to perform the method of one or more of Aspects 1-15.

Aspect 30: A device for wireless communication, comprising a memory and one or more processors coupled to the memory, the one or more processors configured to perform the method of one or more of Aspects 1-15.

Aspect 31: An apparatus for wireless communication, comprising at least one means for performing the method of one or more of Aspects 1-15.

Aspect 32: A non-transitory computer-readable medium storing code for wireless communication, the code comprising instructions executable by a processor to perform the method of one or more of Aspects 1-15.

Aspect 33: A non-transitory computer-readable medium storing a set of instructions for wireless communication, the set of instructions comprising one or more instructions that, when executed by one or more processors of a device, cause the device to perform the method of one or more of Aspects 1-15.

Aspect 34: An apparatus for wireless communication at a device, comprising a processor; memory coupled with the processor, and instructions stored in the memory and executable by the processor to cause the apparatus to perform the method of one or more of Aspects 16-28.

Aspect 35: A device for wireless communication, comprising a memory and one or more processors coupled to the memory, the one or more processors configured to perform the method of one or more of Aspects 16-28.

Aspect 36: An apparatus for wireless communication, comprising at least one means for performing the method of one or more of Aspects 16-28.

Aspect 37: A non-transitory computer-readable medium storing code for wireless communication, the code comprising instructions executable by a processor to perform the method of one or more of Aspects 16-28.

Aspect 38: A non-transitory computer-readable medium storing a set of instructions for wireless communication, the set of instructions comprising one or more instructions that, when executed by one or more processors of a device, cause the device to perform the method of one or more of Aspects 16-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a network node, comprising:
a memory; and
one or more processors coupled to the memory, the one or more processors configured to:
transmit, to a user equipment (UE), a codebook subset restriction (CBSR) criterion that is associated with a coherent joint transmission (CJT) by a plurality of transmission reception points (TRPs) and that indicates that a plurality of spatial bases, associated with the plurality of TRPs, are to be jointly restricted based at least in part on the plurality of spatial bases having a same directionality; and
receive, from the UE, a communication that is based at least in part on the CBSR criterion.

2. The apparatus of claim 1, wherein the one or more processors, to transmit the CBSR criterion, are configured to transmit a CBSR criterion for a CJT that includes a joint codebook for the plurality of TRPs.

3. The apparatus of claim 2, wherein the CBSR criterion for the CJT that includes the joint codebook for the plurality of TRPs indicates a number of relations associated with the plurality of TRPs, wherein each relation of the number of relations is associated with two or more spatial bases of the plurality of spatial bases, and wherein the two or more spatial bases are associated with different TRPs of the plurality of TRPs.

4. The apparatus of claim 1, wherein the one or more processors, to transmit the CBSR criterion, are configured to transmit a CBSR criterion for a CJT that includes separate codebooks for two or more of the plurality of TRPs.

5. The apparatus of claim 4, wherein a number of coefficients for a spatial basis, of the plurality of spatial bases, is equal to a number of frequency bases for a corresponding TRP of the plurality of TRPs.

6. The apparatus of claim 1, wherein the one or more processors are further configured to transmit an indication of a maximum average power associated with the plurality of spatial bases.

7. The apparatus of claim 6, wherein the one or more processors, to transmit the indication of the maximum average power, are configured to:
pair a spatial basis of a first TRP, of the plurality of TRPs, with a corresponding spatial basis of a second TRP, of the plurality of TRPs, based at least in part on the first TRP and the second TRP having a same orientation; and
transmit a maximum average power associated with the spatial basis of the first TRP and the corresponding spatial basis of the second TRP.

8. The apparatus of claim 6, wherein the one or more processors, to transmit the indication of the maximum average power, are configured to:
select a spatial basis of a first TRP, of the plurality of TRPs, and select a spatial basis of a second TRP, of the plurality of TRPs, based at least in part on the first TRP and the second TRP having different orientations; and
transmit a maximum average power associated with the selected spatial basis of the first TRP and the selected spatial basis of the second TRP.

9. The apparatus of claim 1, wherein the one or more processors, to transmit the CBSR criterion, are configured to transmit a CBSR criterion indicating that the plurality of spatial bases are to be jointly restricted for every polarization combination of a plurality of polarization combinations associated with the TRPs.

10. The apparatus of claim 1, wherein the one or more processors, to transmit the CBSR criterion, are configured to transmit a CBSR criterion indicating that the plurality of spatial bases are to be jointly restricted for all polarizations of a plurality of polarizations associated with the TRPs.

11. The apparatus of claim 1, wherein the CJT is associated with a channel state information reference signal resource and the plurality of TRPs are associated with a plurality of port groups.

12. The apparatus of claim 1, wherein the plurality of TRPs are associated with a plurality of channel state information reference signal resources.

13. An apparatus for wireless communication at a user equipment (UE), comprising:
a memory; and
one or more processors coupled to the memory, the one or more processors configured to:
receive, from a network node, a codebook subset restriction (CBSR) criterion that is associated with a coherent joint transmission (CJT) by a plurality of transmission reception points (TRPs) and that indicates that a plurality of spatial bases, associated with the plurality of TRPs, are to be jointly restricted based at least in part on the plurality of spatial bases having a same directionality; and
transmit, to the network node, a communication that is based at least in part on the CBSR criterion.

14. The apparatus of claim 13, wherein the one or more processors, to receive the CBSR criterion, are configured to receive a CBSR criterion for a CJT that includes a joint codebook for the plurality of TRPs.

15. The apparatus of claim 14, wherein the CBSR criterion for the CJT that includes the joint codebook for the plurality of TRPs indicates a number of relations associated with the plurality of TRPs, wherein each relation of the number of relations is associated with two or more spatial bases of the plurality of spatial bases, and wherein the two or more spatial bases are associated with different TRPs of the plurality of TRPs.

16. The apparatus of claim 13, wherein the one or more processors, to receive the CBSR criterion, are configured to receive a CBSR criterion for a CJT that includes separate codebooks for each of the plurality of TRPs.

17. The apparatus of claim 16, wherein a number of coefficients for a spatial basis, of the plurality of spatial bases, is equal to a number of frequency bases for a corresponding TRP of the plurality of TRPs.

18. The apparatus of claim 13, wherein the one or more processors are further configured to receive an indication of a maximum average power associated with the plurality of spatial bases.

19. The apparatus of claim 18, wherein the one or more processors, to receive the indication of the maximum average power, are configured to receive a maximum average power associated with a spatial basis of a first TRP, of the plurality of TRPs, and a corresponding spatial basis of a second TRP, of the plurality of TRPs, based at least in part on the first TRP and the second TRP having a same orientation.

20. The apparatus of claim 18, wherein the one or more processors, to receive the indication of the maximum average power, are configured to receive a maximum average power associated with a selected spatial basis of a first TRP, of the plurality of TRPs, and a selected spatial basis of a second TRP, of the plurality of TRPs, based at least in part on the first TRP and the second TRP having different orientations.

21. The apparatus of claim 13, wherein the one or more processors, to receive the CBSR criterion, are configured to receive a CBSR criterion indicating that the plurality of spatial bases are to be jointly restricted for every polarization combination of a plurality of polarization combinations associated with the TRPs.

22. The apparatus of claim 13, wherein the one or more processors, to receive the CBSR criterion, are configured to receive a CBSR criterion indicating that the plurality of spatial bases are to be jointly restricted for all polarizations of a plurality of polarizations associated with the TRPs.

23. The apparatus of claim 13, wherein the CJT is associated with a channel state information reference signal resource and the plurality of TRPs are associated with a plurality of port groups.

24. The apparatus of claim 13, wherein the plurality of TRPs are associated with a plurality of channel state information reference signal resources.

25. A method of wireless communication performed by a network node, comprising:
transmitting, to a user equipment (UE), a codebook subset restriction (CBSR) criterion that is associated with a coherent joint transmission (CJT) by a plurality of transmission reception points (TRPs) and that indicates that a plurality of spatial bases, associated with the plurality of TRPs, are to be jointly restricted based at least in part on the plurality of spatial bases having a same directionality; and
receiving, from the UE, a communication that is based at least in part on the CBSR criterion.

26. The method of claim 25, wherein transmitting the CBSR criterion comprises transmitting a CBSR criterion for a CJT that includes a joint codebook for the plurality of TRPs.

27. The method of claim 25, wherein transmitting the CBSR criterion comprises transmitting a CBSR criterion for a CJT that includes separate codebooks for two or more of the plurality of TRPs.

28. A method of wireless communication performed by a user equipment (UE), comprising:
receiving, from a network node, a codebook subset restriction (CBSR) criterion that is associated with a coherent joint transmission (CJT) by a plurality of transmission reception points (TRPs) and that indicates that a plurality of spatial bases, associated with the plurality of TRPs, are to be jointly restricted based at least in part on the plurality of spatial bases having a same directionality; and
transmitting, to the network node, a communication that is based at least in part on the CBSR criterion.

29. The method of claim 28, wherein receiving the CBSR criterion comprises receiving a CBSR criterion for a CJT that includes a joint codebook for the plurality of TRPs.

30. The method of claim 28, wherein receiving the CBSR criterion comprises receiving a CBSR criterion for a CJT that includes separate codebooks for each of the plurality of TRPs.
